(19) United States
(12) Patent Application Publication
(10) Pub. No.: US 2010/0004084 A1
(43) Pub. Date: Jan. 7, 2010

(54) Variable speed belt

(76) Inventors: Xinjian Fan, Novi, MI (US); Leslee Wayne Brown, Rochester Hills, MI (US); Ralph M. Duke, Lapeer, MI (US); Yoshitaka Sato, Nara (JP)

Correspondence Address: THE GATES CORPORATION, IP LAW DEPT. 10-A3, 1551 WEWATTA STREET, DENVER, CO, 80202, US

(21) Appl. No.: 12/217,026

(22) Filed: Jul. 1, 2008

(51) Int. Cl. F16G 5/20

(52) U.S. Cl. 474/242

(57) ABSTRACT

A variable speed belt comprising an elastomeric body, a tensile cord disposed within the elastomeric body and extending in an endless direction, a cog extending from the body, the cog comprising opposing flanks, each flank comprises a first planar surface describing an included angle (α), the first planar surface engageable with a sheave, each flank comprises a second planar surface disposed toward a cog tip describing an included angle (β); and included angle (α) is not equal to the included angle (β).

### FIELD OF THE INVENTION

The invention relates to a variable speed belt, and more particularly, to a variable speed belt comprising a cog flank having a first planar surface disposed at a first angle for engaging a sheave and a cooperating second planar surface disposed at a second angle that is not engagable with a sheave surface.

### BACKGROUND OF THE INVENTION

The belt plays an important role in the operation of variable speed power transmission systems. As a flexible element, the belt connects two pairs of sheaves through friction to transmit power from the driving shaft to the driven shaft. Each pair of sheaves includes a fixed sheave and a movable sheave. By controlling the axial movement of movable sheaves, the speed and torque ratio is changed. During operation, the belt sustains extreme longitudinal tension and transversal compression. To achieve maximum performance, efficiency, and durability, one of the main challenges the belt design faces is meeting contradictory requirements, high longitudinal flexibility but high transversal stiffness while maintaining proper side contact.

Representative of the art is U.S. Pat. No. 5,328,412 (1994) which discloses an apparatus and a method for generating same provides a pulley sheave inner face profile for a variable pulley of a continuously variable transmission allowing the crowned face chain-belt centerline to remain in a plane substantially perpendicular to the axis of the pulleys at all times and at all drive ratios. Given a primary pulley sheave inner face profile, a corresponding secondary pulley sheave inner face profile can be developed to achieve substantially perfect belt alignment. The pulley sheave inner face profiles may be designed to be identical or congruent. Congruent pulley sheave inner face profiles can be developed according to an algebraic solution allowing numerically controlled design and manufacturing techniques in the fabrication of the sheave inner faces.

What is needed is a variable speed belt comprising a cog flank having a first planar surface disposed at a first angle for engaging a sheave and a cooperating second planar surface disposed at a second angle that is not engagable with a sheave surface. The present invention meets this need.

### SUMMARY OF THE INVENTION

The primary aspect of the invention is to provide a variable speed belt comprising a cog flank having a first planar surface disposed at a first angle for engaging a sheave and a cooperating second planar surface disposed at a second angle that is not engagable with a sheave surface.

Other aspects of the invention will be pointed out or made obvious by the following description of the invention and the accompanying drawings.

The invention comprises a variable speed belt comprising an elastomeric body, a tensile cord disposed within the elastomeric body and extending in an endless direction, a cog extending from the body, the cog comprising opposing flanks, each flank comprises a first planar surface describing an included angle (α), the first planar surface engageable with a sheave, each flank comprises a second planar surface disposed toward a cog tip describing an included angle (β); and included angle (α) is not equal to the included angle (β).

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1A is a side view of a prior art v-belt cog.

FIG. 1B is a perspective view of the prior art v-belt cog in FIG. 1A.

FIG. 2A is a side view of a prior art v-belt cog.

FIG. 2B is a perspective view of the prior art v-belt cog in FIG. 2A.

FIG. 3 is an elevation view of an inventive cog.

FIG. 4 is a side view of the cog in FIG. 3.

FIG. 5 is a table of example dimensions for different example belts.

FIG. 6 is a side view of a cog.

FIG. 7 is a table of example dimensions for different example cogs for different example belts.

FIG. 8 is a variable speed system.

FIG. 9 is a cross-section of a variable speed pulley sheave.

FIG. 10A is a summary of the drive/testing conditions that the finite element analysis (FEA) models simulated.

FIG. 10B is a summary of the results of the FEA modeling for the inventive belt.

FIG. 11 is a graph comparing audible noise during idle for the inventive belt with the prior art.

FIG. 12 is a chart showing a noise comparison with the engine off, rotated by hand.

FIG. 13 is a chart showing a noise comparison with the engine on.

FIG. 14 is a chart showing a comparison of time versus speed for a vehicle.

### DETAILED DESCRIPTION OF THE PREFERRED EMBODIMENT

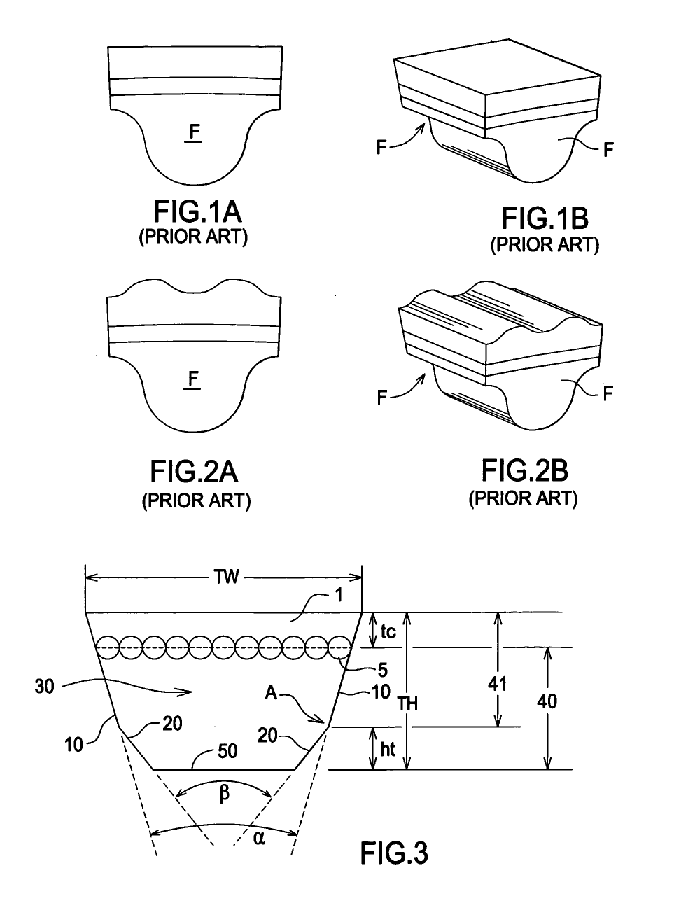

The invention comprises a cogged variable speed belt. To satisfy these special design requirements, a cogged V-belt design is adopted in variable speed drives. FIG. 1A is a side view of a prior art v-belt cog. FIG. 1B is a perspective view of the prior art v-belt cog in FIG. 1A.

To further increase transversal stiffness while still maintain high flexibility and suitable contact area, a double cog belt design, in which additional cogs are added on the top of belt, is conventionally used. FIG. 2A is a side view of a prior art v-belt cog. FIG. 2B is a perspective view of the prior art v-belt cog in FIG. 2A. However, the double cog design has drawbacks including a more complex manufacturing process and higher cost. In each prior art belt, cog opposing flanks (F) each contact a sheave during operation to transmit torque. Each flank (F) is substantially planar surface.

FIG. 3 is an elevation view of an inventive cog. The inventive belt comprises a body 1. Embedded within the body 1 are tensile members 5. Tensile members 5 bear the tensile load which the belt is subjected to during operation. Tensile members 5 extend in the endless, longitudinal direction through the belt.

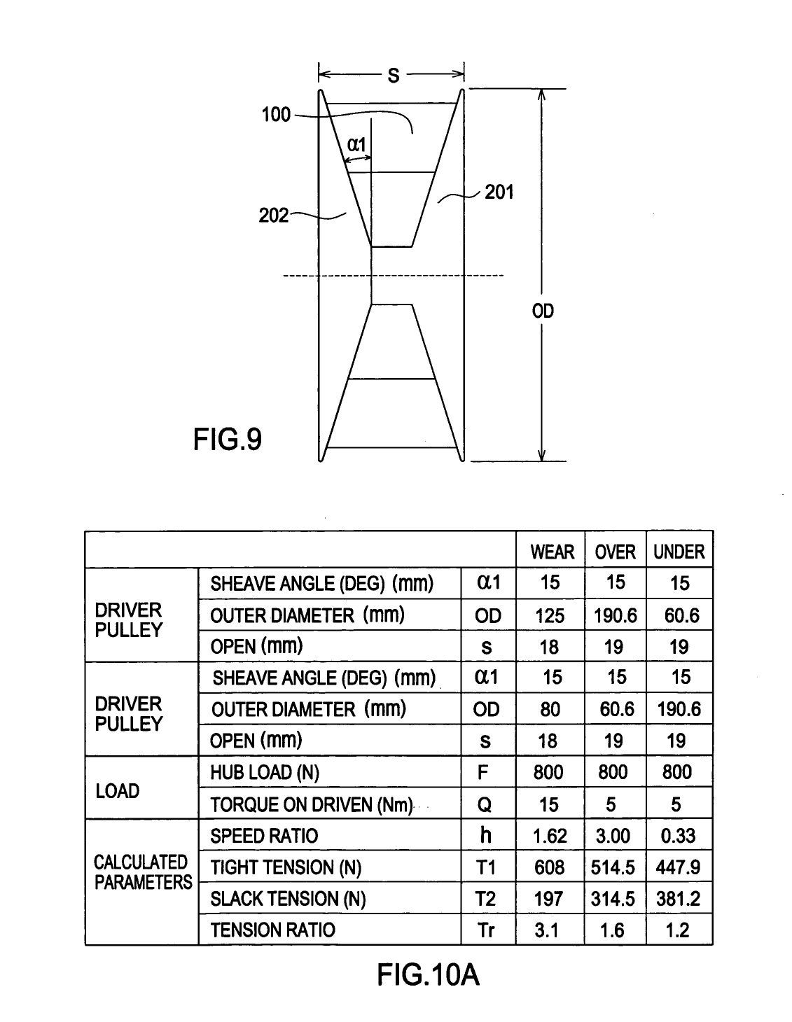

Extending from the belt body is a plurality of cogs 30. The cogs are disposed along the entire length of the belt. Each cog 30 comprises a substantially planar flank surface 10 and a substantially planar flank surface 20. Each flank surface 10 engages a sheave, see FIG. 9, during operation.

Each pair of opposing flank surfaces 10 describe an included angle α. Included angle α is substantially equivalent to two times a sheave angle α1, see FIG. 9.

Each cog further comprises an opposing pair of second flank surfaces 20 which are disposed toward a cog tip 50 and which are cooperating with the first flank surfaces 10. Each pair of second flank surfaces 20 describe an included angle β.

Angle α is in the range of approximately 15° to 50° (˜7° to ˜25° per pulley sheave angle α1). Angle β is in the range of approximately 25° to 65°. Namely, β°=α°+(2×relief angle)°. The “relief angle” is equal to or greater than approximately 5°. It is believed the cooperating nature of the first flank surfaces and second flank surfaces results in a significant reduction in noise generated by the belt during operation. All numeric values used in this specification to describe the invention are examples only and are not intended to limit the breadth or applicability of the invention.

By way of example, the second flank surface 20 may comprise a relief angle of approximately 5° which prevents the second flank surface 20 from coming in contact with a sheave. Assuming an angle α of 20°, this gives an angle β of 30°. This configuration will run on sheaves having a 74 mm diameter. This configuration reduces the belt flank contact with the sheave by over 50% compared to a prior art belt. This results in an undercord (40, see FIG. 3) thickness of about 12 mm total thickness reduced to a contact length of again about 5.5 mm.

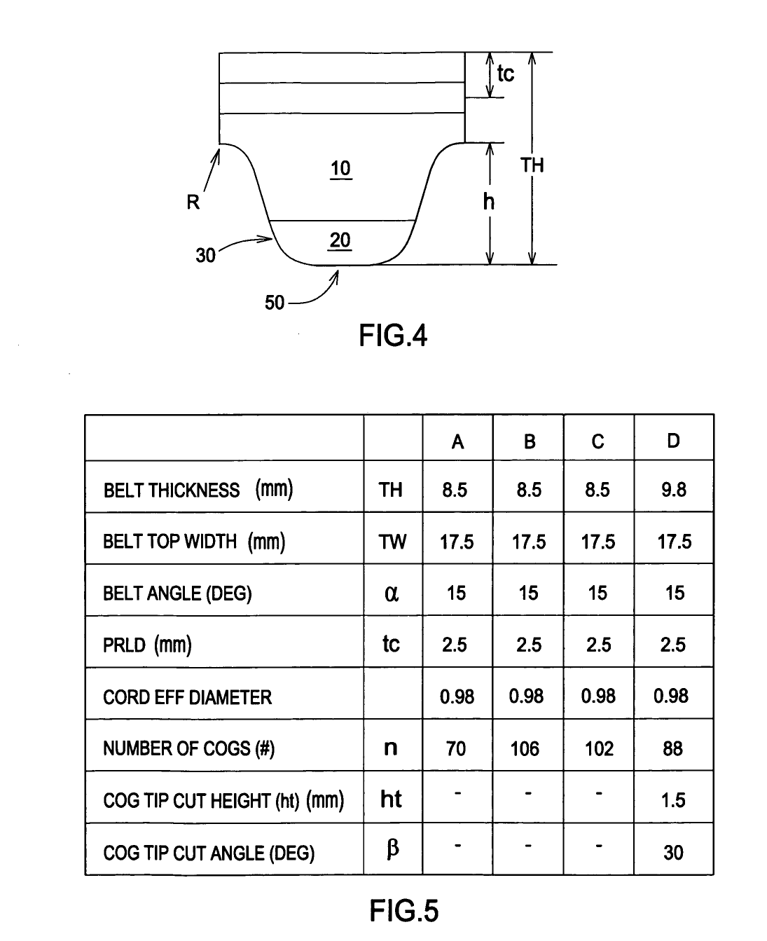

FIG. 4 is a side view of the cog in FIG. 3. The belt body 1 may comprise chloroprene, EPDM, or HNBR. The tensile cords 5 may comprise polyester, nylon, Kevlar, aramid or any other suitable material known in the art. Fiber reinforcement used within the body may comprise cotton, polyester, aramid (all variants including PBO), carbon and various combinations or blends of these. The fiber lengths may be in the range of 0.5 mm up to 10 mm.

The belts may also comprise a laminated fabric where a separate fabric layer is applied to the outside surface of the cogs. The fabric layer improves transverse stiffness each cog. The fabric may comprise polyester, cotton, nylon, aramid or any combination of two or more of the foregoing.

The inventive cog flank configuration is effective when used on variable speed drives characterized by a large amount of power transferred over a comparably small diameter sheave. In these cases the significant amount of bending coupled with high tensions can create large contact forces on the sides of the cogs and result in a significant amount of load being transferred at a larger distance (40) from the cord line than desired.

By use of the relieved second flank surface 20 the resistance to bending to moments acting in parallel to the belt length is maintained. At the same time the transfer of power is controlled so that it happens in a more stable region (41, see FIG. 3) which is closer to the pitch line of the belt. For the purposes of this specification, the pitch line is the centerline of the tensile members 5.

The existing prior art belts also have a variation in torque on the pulleys that is related to cog spacing and is associated with cog entry and exit into the sheaves. During cog entry and exit the variability of the area in contact and where forces are transferred creates an excitation and a noise related to the meshing frequencies of the cogs. By extending the flank second surface 20 up to the root of the cog, the magnitude of the excitation is diminished until at that point a uniform contact surface between the sheaves and the belt is established that is independent of the cog spacing and size. This creates a smooth running transition between the belt and the sheaves and is expected to reduce both the “meshing” noise and other noises, such as friction induced instability noise, for which a larger distance between the center of the force applied to the pitch line increases in likelihood.

Angle β must be sufficient to prevent the flank second surface 20 from establishing an initial significant contact force due to its contact with the sheave. This means that the angle β can be selected to accommodate differences in the cog's transverse stiffness.

For example, if a relatively soft elastomeric compound is used which results in a relatively soft transverse stiffness, a comparatively larger angle β is used to prevent undesired contact between surface 20 and a sheave surface.

The apex A of the angle between surface 10 and surface 20 should be spaced a distance from the pitch line, or tensile members 5, in order to prevent the contact between surface 20 and the sheave from being established. This is determined by considering the pressure that is expected and calculated based on the range of friction expected. This allows the desired load transfer to occur through the mechanism of friction. Too small of a contact zone is not desired.

In the end the belt profile geometry, the shape of the cog, the position of the cog as measured from the pitch line or tensile member (if the two are not coincident), and the double angle are selected to maximize the bending flexibility around the transverse axis (across the width of the belt), maintain bending stiffness around the axis defined by the belt length, and provide an adequate contact zone between the belt and the sheaves to transfer the load to and from the sheaves.

It can also be noted that the tensile member's location should be such that the tensile strength of the belt is sufficient and also be close enough to the cog root (R, FIG. 4) to balance the two bending stiffnesses between desired levels. Thus the tensile cord position can be selected based on the drive's parameters (width of belt (TW) and sheave angle α1), the first angle selected to fit the sheave, the distance to the cog root selected to provide a sufficient contact zone and maximize bending flexibility, and then the second angle determined to account for the cog stiffness, contact zone, and noise control.

FIG. 5 is a table of example dimensions for different example belts. Belts A, B, C and D are shown. The variables are described in FIGS. 3, 4 and 6. The “cord effective diameter” is the diameter of each tensile cord 5.

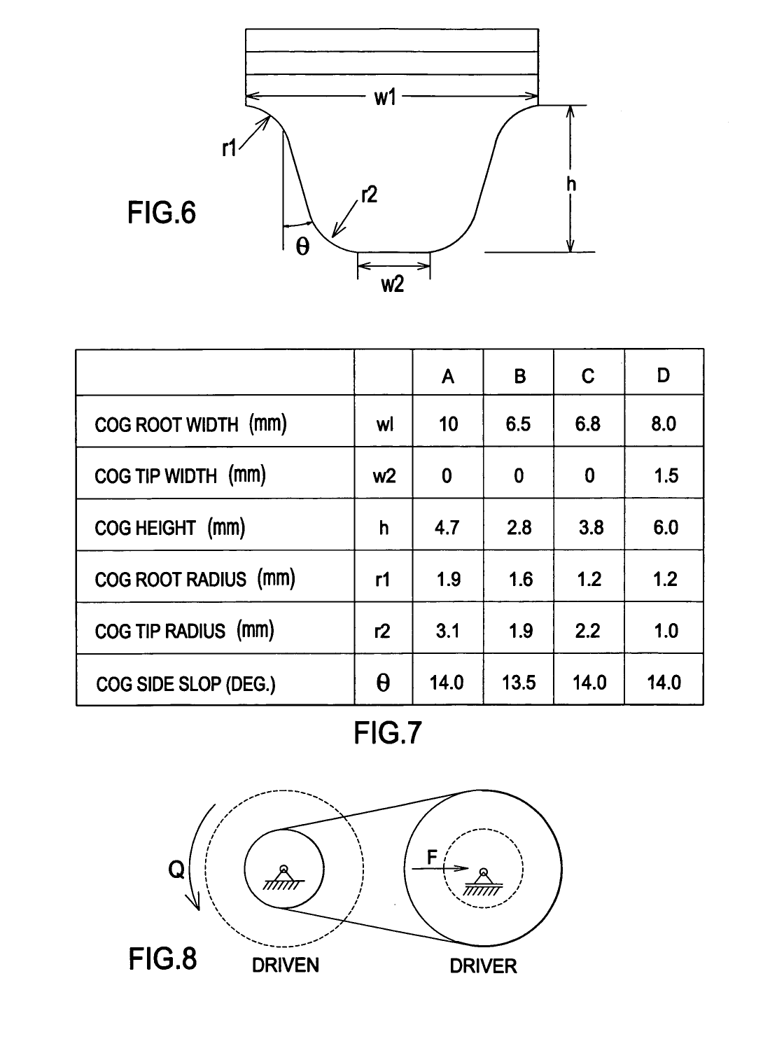

FIG. 6 is a side view of a cog. The height of the cog is “h”. The width of the cog is w1. The tip radius is r2. The root radius is r1. The cog side angle is angle θ. The cog tip width is w2.

FIG. 7 is a table of example dimensions for different example cogs for different belts. Belts A, B, C and D are shown. The cog is shown in FIG. 6.

FIG. 8 is a variable speed system. The belt is engaged between the driver and driven pulley sheaves.

FIG. 9 is a cross-section of a variable speed pulley sheave. Belt 100 is shown in the operating condition between sheaves 201 and 202. Sheaves 201 and 202 move axially with respect to each other in a manner known in the art. Sheave angle α1 equates to one half of included angle α as described in FIG. 3. OD is the outside diameter of the sheave.

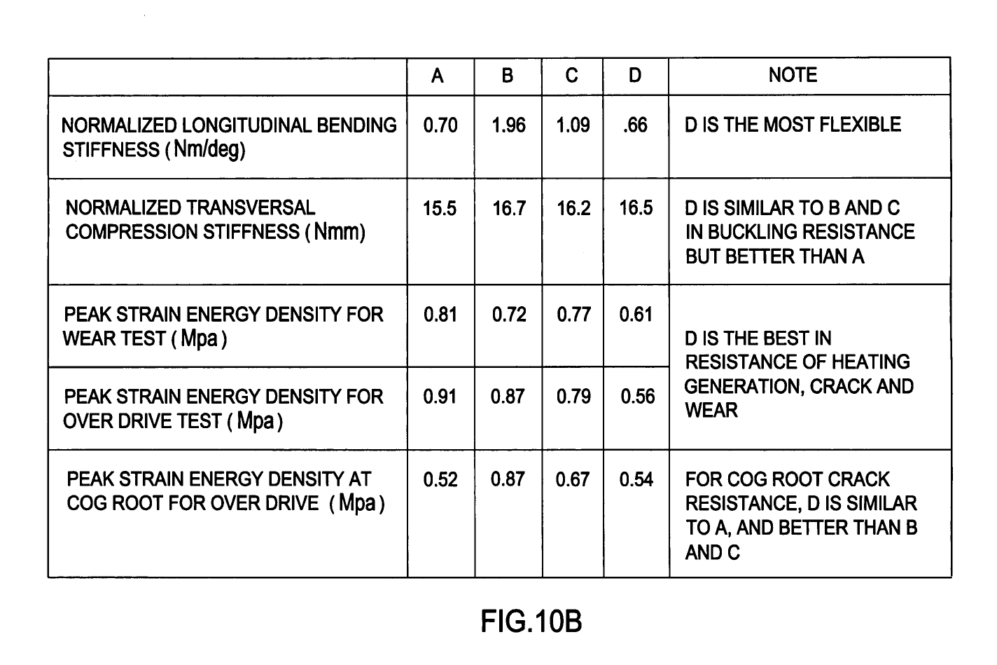

FIG. 10A is a summary of the drive/testing conditions that the finite element analysis (FEA) models simulated. Three FEA models are considered to simulate three drive/testing conditions: wear test, over drive, and under drive. For each drive condition, the pulley dimensions, the applied loads (hub force, and torque), and the corresponding speed ratio, belt tight side tension, belt slack side tension, and tension ratio are listed in the table.

FIG. 10B is a summary of the results of the FEA modeling for the inventive belt. Belts A, B, C are prior art belts. Belt D is the inventive belt. One can see that in terms of basis design characteristics the inventive belt compared favorably with the prior art belts.

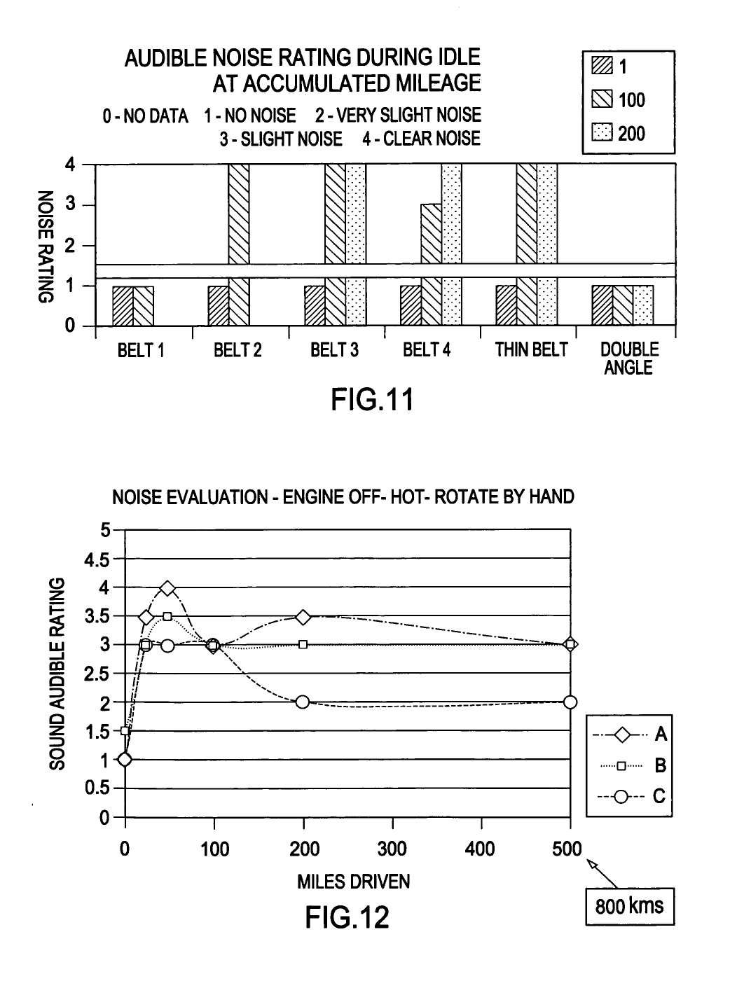

FIG. 11 is a graph comparing audible noise during idle for the inventive belt with the prior art. The belt noise is observed during idling. For the test a subjective sound jury was used (human perception: did you hear a noise?) in addition to sound pressure measurements using an “A” weighting filter. In general, the subjective information was given a greater weight than the sound pressure measurements since the human ear has shown to be more reliable for judging this noise characteristic from a customer point of view.

Belts 1 through 4 used prior art geometry (similar cogs, flat flanks see FIGS. 1, 1A, 2, 2A). Another belt that is shown is a “thin belt” which also relies on the prior art geometry. The inventive belt is identified as “double angle”.

The “y” axis depicts the noise rating from 1 (no noise) to 4 (clear noise). The “x” axis depicts each of the belts. For each belt information is provided for tests conducted following 1 mile of use, 100 miles of use and 200 miles of use. The graph shows that following 1, 100 and 200 miles of testing the only belt that does not generate any subjective noise at all three distances is the inventive “double angle” belt. Hence, the inventive belt is shown to be more quiet than prior art belts and is suitably durable.

FIG. 12 is a chart showing a noise comparison with the engine off, rotated by hand. The test vehicle engine was not operating and was rotated by hand. The test vehicle was a commercially available all terrain vehicle (ATV) using a Rotax® 800 HO EFI V-twin engine.

Two prior art belts (A), (B) and compared with the inventive belt (C). As total miles driven exceed 100 miles, the noise generated by the inventive belt (C) is significantly less than the prior art belts (A) and (B). The test criteria were subjective and based on a comparison of the relative noise levels for each belt as detected by human observers.

The included angle (α) for the inventive belt used in the test was approximately 26 degrees. The included angle (β) for the inventive belt used in the test was approximately 36 degrees.

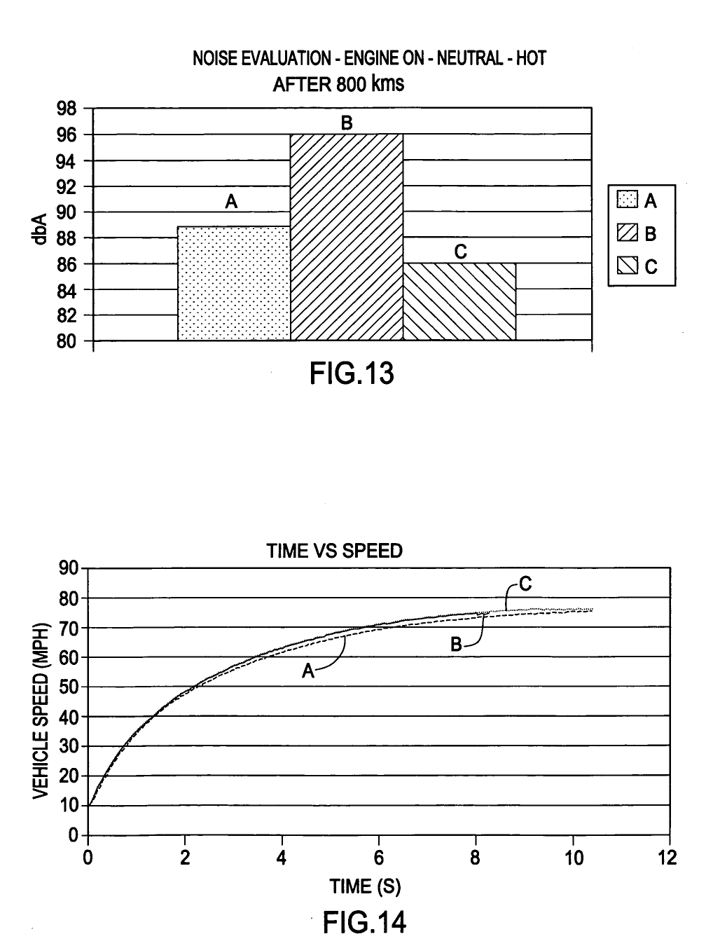

FIG. 13 is a chart showing a noise comparison with the engine on. The inventive belt (C) was significantly more quiet (86 dbA) than the two prior art belts, (A) at 89 dbA and (B) at 96 dbA. The test vehicle engine was operating at operating temperature and in neutral. The belts each had 800 kms of use. The measurements were made using a sound meter (dBA).

FIG. 14 is a chart showing a comparison of time versus speed for a vehicle. The inventive belt resulted in test vehicle performance which was an improvement over the prior art belts.

| Belt | Top Speed | Time to Speed |
|---|---|---|
| A | 74.86 mph | 8.27 sec |
| B | 75.82 mph | 10.35 sec |
| C | 76.51 mph | 10.37 sec |

The data were developed after 200 miles of use for each belt. The testing was performed on an inertia dynamometer.

Although forms of the invention have been described herein, it will be obvious to those skilled in the art that variations may be made in the construction and relation of parts without departing from the spirit and scope of the invention described herein.

We claim:

1. A variable speed belt comprising:
an elastomeric body;
a tensile cord disposed within the elastomeric body and extending in an endless direction;
a cog extending from the body;
the cog comprising opposing flanks;
each flank comprises a first planar surface describing an included angle (α), the first planar surface engageable with a sheave;
each flank comprises a second planar surface disposed toward a cog tip describing an included angle (β); and
included angle (α) is not equal to the included angle (β).

2. The variable speed belt as in claim 1, wherein the included angle (α) is in the range of approximately 15° to approximately 50°.

3. The variable speed belt as in claim 1, wherein the included angle (β) is in the range of approximately 25° to 65°.

4. The variable speed belt as in claim 2, wherein the included angle (β) is calculated using the formula: β°=α°+(2×relief angle)°, wherein the relief angle is equal to or greater than approximately 5°.

5. The variable speed belt as in claim 1, wherein the second planar surface does not come into contact with a sheave surface.

6. The variable speed belt as in claim 1, wherein the included angle (β) is approximately 36 degrees.

7. The variable speed belt as in claim 1, wherein the included angle (α) is approximately 26 degrees.
